(19) United States
(12) Patent Application Publication
(10) Pub. No.: US 2026/0111284 A1
(43) Pub. Date: Apr. 23, 2026

(54) OUT-OF-BAND MANAGEMENT OF COMMUNICATION MODALITIES USED BY DATA PROCESSING SYSTEMS

(71) Applicant: Dell Products L.P., Round Rock, TX (US)

(72) Inventors: BASSEM EL-AZZAMI, Austin, TX (US); ABEYE TESHOME, Austin, TX (US); RICHARD M. TONRY, Georgetown, TX (US); ADOLFO SANDOR MONTERO, Pflugerville, TX (US); GOKUL THIRUCHENGODE VAJRAVEL, Bangalore (IN); MOHIT ARORA, Frisco, TX (US); VINODKUMAR VASUDEV OTTAR, McKinney, TX (US); LUIS ANTONIO VALENCIA REYES, Waxahachie, TX (US); RAJARAVI CHANDRA KOLLARAPU, Allen, TX (US)

(21) Appl. No.: 18/920,084

(22) Filed: Oct. 18, 2024

(51) Int. Cl. G06F 9/50; G06F 21/57

(52) U.S. Cl. CPC G06F 9/5055; G06F 21/57

(57) ABSTRACT

Methods and systems for managing operation of a data processing system are disclosed. Hardware resources of the data processing system may use an existing secure communication modality when providing computer-implemented services. A management controller of the data processing system may identify that a secure communication modification event for the data processing system has occurred. Based on the identification, the management controller may perform a process to obtain an action for modifying the existing secure communication modality. The process may be based on a context of operation of the hardware resources and a schema that associates different contexts with different secure communication modalities. The action may be performed to obtain an updated secure communication modality. The hardware resources may use the updated secure communication modality to provide the computer-implemented services.

### FIELD

Embodiments disclosed herein relate generally to managing data processing systems. More particularly, embodiments disclosed herein relate to systems and methods to manage secure communication modalities used by the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a distributed system in accordance with an embodiment.

FIG. 1B shows a block diagram illustrating a data processing system in accordance with an embodiment.

FIG. 2A shows a data flow diagram in accordance with an embodiment.

FIG. 2B shows an interaction diagram in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may provide computer-implemented services. To provide the computer-implemented services, hardware resources of the data processing system may communicate with one another, other components of the data processing system, and/or other devices. For example, the data processing system may include in-band components (e.g., the hardware resources) and out-of-band components (e.g., a management controller). The out-of-band components may operate independently from the in-band components, and may include functionality for managing operation of the in-band components and/or other functionality that may facilitate provisioning of the computer-implemented services.

The communication between (e.g., facilitating cooperative operation with) the hardware resources, the other components, and/or the other devices may be facilitated over communication channels of the data processing system using a secure modality of communication (e.g., a communication protocol configured based on a set of parameters for the communication protocol). For example, the secure communication modality may be configured to meet communication requirements for providing the computer-implemented services. However, over time the communication requirements may change, and therefore a static communication link (e.g., a communication channel facilitating a single, static modality of communication) may not be adequate for providing desired (e.g., time-efficient, secure) computer-implemented services. Therefore, a dynamic communication link may be implemented to reflect a variation in communication requirements over time. The communication requirements may be defined in part, by different contexts of operation of the hardware resources.

To implement the dynamic communication link, the out-of-band components may identify occurrences of events for the data processing system that may result in a change in communication requirements (e.g., secure communication modification events). Upon identification of an occurrence of a secure communication modification event, a context of operation of the hardware resources may be obtained. For example, the context of operation of the hardware resources may be obtained based on a location of the data processing system, a time of occurrence of the secure communication modification event, a security status of the hardware resources, a network connection status of the data processing system, and/or other information regarding the data processing system.

Based on the context of the operation of the hardware resources, actions for modifying an existing secure communication modality used by the hardware resources may be obtained. To do so, the out-of-band components may perform a communication management process using a schema that associates different contexts of operation with different secure communication modalities. The out-of-band components may initiate performance of the actions to obtain an updated secure communication modality used by the hardware resources that meets current communication requirements in order to provide the desired computer-implemented services.

By using out-of-band methods (e.g., out-of-band components and/or communications) to manage secure communication modalities used by the hardware resources based on a context of their operation, the hardware resources may be more likely to provide the desired computer-implemented services compared to in-band methods that rely on potentially compromised and/or inoperable hardware resources to manage the secure communication modalities.

In an embodiment, a method for managing operation of a data processing system is provided. The method may include: making an identification, by a management controller of the data processing system, of an occurrence of a secure communication modification event for the data processing system. Based on the identification, the method may include: performing, by the management controller, a communication management process based on a context of operation of hardware resources of the data processing system and a schema that associates different contexts with different secure communication modalities to obtain at least one action; performing, by the management controller, the at least one action to modify an existing secure communication modality used by the hardware resources to obtain an updated secure communication modality, and, providing, by the hardware resources, computer-implemented services using the updated secure communication modality.

Each of the different secure communication modalities may utilize a communication protocol of multiple communication protocols and a set of parameters of multiple sets of parameters for the communication protocol.

The context of operation of the hardware resources may be based on at least: a location of the data processing system; a time of the occurrence of the secure communication modification event; a security status of the hardware resources; and, a network connection status of the data processing system.

The context of operation of the hardware resources may be further based on: information regarding whether the data processing system is lost and/or stolen; ownership information for the data processing system; and, information regarding the data processing system provided by another system.

The schema may include policies for the data processing system, and each policy of the policies may define a secure communication modality of the different secure communication modalities with a corresponding context of the different contexts. Each of the policies may be keyed to different secure communication modification events for the data processing system.

The at least one action may modify a quantity of memory of the hardware resources reserved for the existing secure communication modality. The at least one action may migrate a region of memory of the hardware resources reserved for the existing secure communication modality. The updated secure communication modality may prevent communication previously provided by the existing secure communication modality.

The data processing system may include a network module adapted to separately advertise network endpoints for the management controller and the hardware resources, the network endpoints being usable by a remote system to address communications to the hardware resources and the management controller to facilitate the providing of the computer-implemented services.

An out-of-band communication channel that services the management controller may run through the network module, an in-band communication channel that services the hardware resources may also run through the network module, and a sideband channel may facilitate the updated secure communication modality.

A non-transitory media may include computer instructions that when executed by a processor cause the computer-implemented method to be performed.

The data processing system may include the non-transitory media and a processor, and may perform the computer-implemented method when the computer instructions are executed by the processor.

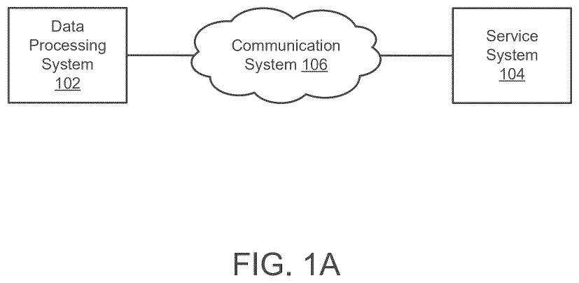

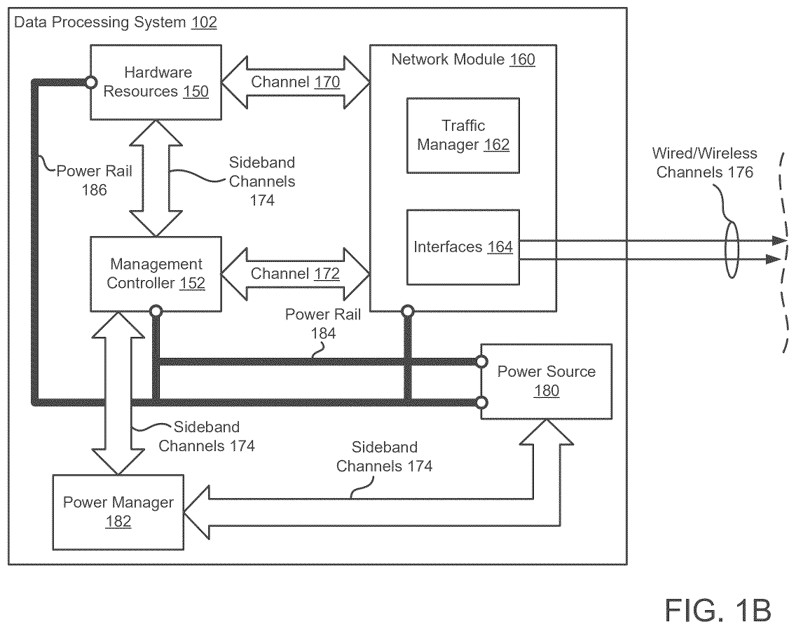

Turning to FIG. 1A, a block diagram illustrating a distributed system in accordance with an embodiment is shown. The system shown in FIG. 1A may provide computer-implemented services. The computer-implemented services may include any type and quantity of computer-implemented services. For example, the computer-implemented services may include communication services, data storage services, database services, data generation services, and/or any other type of service that may be implemented with a computing device.

To provide at least a portion of the computer-implemented services, the system may include a data processing system (e.g., data processing system 102). The data processing system may include hardware resources (e.g., hardware and/or software components) that may operate in coordination with one another (and/or other devices) to provide computer-implemented services to a user of the data processing system and/or to other downstream consumers of the computer-implemented services. For example, the hardware resources may use various communication channels of the data processing system to communicate with one another, with other components of the data processing system, and/or other devices.

The data processing system may include out-of-band components such as a management controller, and the management controller may operate independently from in-band components of the data processing system (e.g., the hardware resources). For example, the management controller may manage operation of the hardware resources and/or perform other actions that may facilitate provisioning of the computer-implemented services, even while the hardware resources are compromised and/or inoperable. To do so, the management controller may communicate with (e.g., transmit data to and/or obtain data from) the hardware resources over communication channels that connect the management controller and the hardware resources (e.g., sideband channels) using a secure communication modality.

The secure communication modality may use a communication protocol and may be configured using a set of parameters for the communication protocol. For example, the secure communication modality may meet requirements for communication between the management controller and the hardware resources, and may specify various quantities and/or locations within memory reserved for facilitating secure communications between the management controller and the hardware resources.

Over time, the communication requirements may vary; therefore a static link that relies on a single communication modality may not meet efficiency and/or security requirements, depending on a context of operation of the hardware resources. For example, communication requirements for the hardware resources may depend on a network connection status of the data processing system, a location of the data processing system, a security status of the hardware resources, etc. Therefore, depending on the context of operation of the hardware resources, different secure modalities of communication may be required in order to provide desired (e.g., reliable, secure, time and/or resource efficient) computer-implemented services.

To increase a likelihood of providing the desired computer-implemented services, a dynamic link with functionality for facilitating multiple secure communication modalities used by the hardware resources may be managed based on the contexts of operation of the hardware resources. However, in some circumstances, such as when the hardware resources are inoperable and/or compromised by a malicious party, the hardware resources may not be able to reliably manage modifications to the dynamic link and/or the dynamic link may become susceptible to malicious use via compromised hardware resources.

In general, embodiments disclosed herein may provide methods, systems, and/or devices for managing operation of a data processing system in a manner that provides secure and efficient communications between the hardware resources, the out-of-band components, and/or other devices. To do so, use of different secure communication modalities facilitated by the dynamic link may be managed by the out-of-band components (e.g., the management controller), which may be more likely to remain secure and operable than the hardware resources.

For example, the management controller may identify occurrences of secure communication modification events for the data processing system. The secure communication modification events may include events that, upon occurrence, may cause changes in communication requirements for the hardware resources. For example, upon occurrence of a secure communication modification event, an existing secure communication modality used by the hardware resources may be compromised and/or may be inefficient for facilitating desired computer-implemented services.

Therefore, to increase a likelihood of providing the desired computer-implemented services, the management controller may identify actions to modify the existing secure communication modality based on a schema keyed to different secure communication modification event for the data processing system and/or different contexts of operation of the hardware resources. The actions may be performed to update the existing secure communication modality used by the hardware resources. The updated secure communication modality may be more likely to facilitate the desired computer-implemented services.

The management controller may use out-of-band communication channels of the data processing system to obtain information regarding the data processing system from a trusted remote system. The information may be usable to identify occurrences of secure communication modification events and/or to define different contexts of operation of the hardware resources.

The out-of-band communication channel may be more reliable for obtaining the information than in-band communication channels that service the (potentially compromised) hardware resources.

Thus, by managing the secure communication modalities using out-of-band methods, the data processing system may be more likely to provide efficient and secure communication channels that service the hardware resources than when relying on in-band components and in-band communication channels to do so.

To provide the above-mentioned functionality, the distributed system of FIG. 1A may include data processing system 102, service system 104, and communication system 106. The distributed system, any components thereof, and/or any other types of devices or components not shown in FIG. 1A may perform all, or a portion of the computer-implemented services independently and/or cooperatively. Each of these components is discussed below.

Data processing system 102 may include any number of data processing systems, and may be operated directly or indirectly (e.g., via other devices) by any number of users. Data processing system 102 may include in-band components (e.g., the hardware resources) and out-of-band components (e.g., the management controller). The hardware resources may include hardware and/or software components (e.g., hosted by the hardware components) with functionality for obtaining context data for data processing system 102. Refer to the discussion of FIG. 1B for more information regarding components of data processing system 102.

The context data may include, for example, location data for data processing system 102, a network connection status for data processing system 102, a security status for data processing system 102, and/or other information usable, at least in part, to define a context of operation of the hardware resources (e.g., activity of the hardware resources such as ongoing and/or queued processes for performance by the hardware resources).

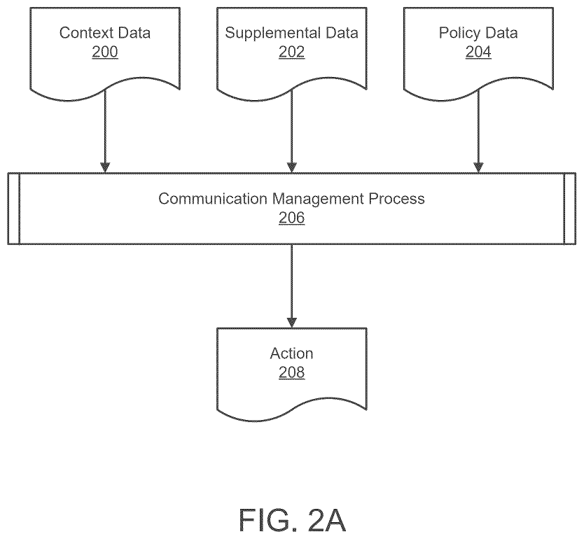

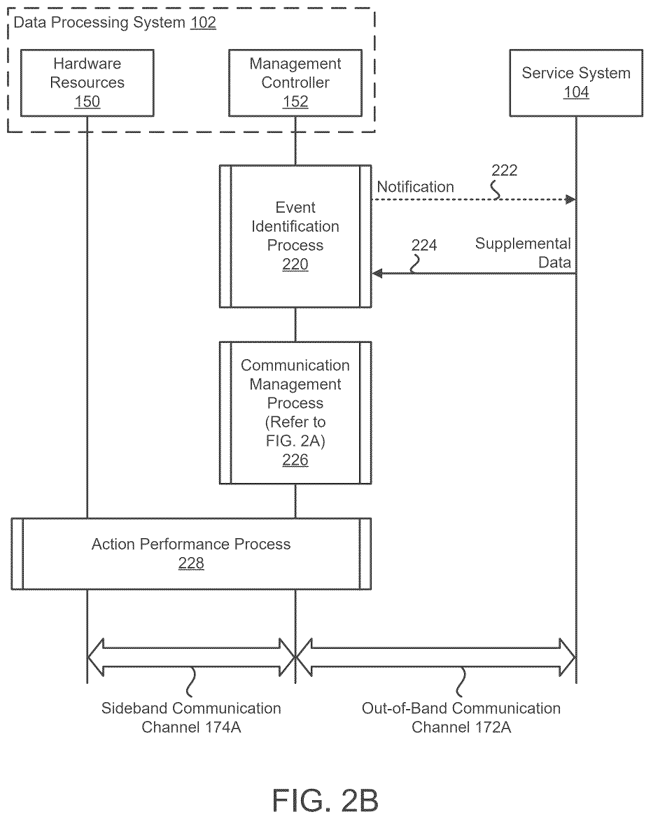

The out-of-band components may include functionality for managing secure communication modalities used by the hardware resources. For example, the management controller may (i) identify occurrences of secure communication modification events for data processing system 102, (ii) perform communication management processes based on the secure communication modification events to obtain actions usable to modify existing secure communication modalities used by the hardware resources, (iii) initiate performance of the actions to obtain updated secure communication modalities usable by the hardware resources to provide computer-implemented services, and/or (iv) otherwise manage operation of the hardware resources (e.g., communication links used by the hardware resources). Refer to the discussion of FIG. 2B for more information regarding managing secure communication modalities based on secure communication modification events for data processing system 102.

To perform the communication management processes, the management controller may (i) obtain context data (e.g., from the hardware resources, via sideband communication channels connecting the management controller and the hardware resources), (ii) manage and/or enforce policies for data processing system 102, and/or (iii) communicate with trusted remote systems to obtain supplemental data regarding data processing system 102. For example, the management controller may include functionality for exchanging data with other devices (e.g., trusted remote systems) via out-of-band communication channels to obtain the supplemental data and/or other information (e.g., new and/or updated policies for data processing system 102). Refer to the discussion of FIG. 2A for more information regarding communication management processes.

Service system 104 may include any number of systems that provide computer-implemented (e.g., Cloud) services for data processing system 102. For example, service system 104 may include a system trusted by data processing system 102 to provide provisioning services, policy management services, and/or other services relating to managing operation of data processing system 102. To perform the services, service system 104 may communicate and/or exchange data with components of data processing system 102 (e.g., the management controller via out-of-band communication channels and/or the hardware resources via in-band communication channels).

For example, service system 104 may (i) obtain notifications from the management controller (e.g., indicating a change in state of data processing system 102, indicating occurrence of a secure communication modification event for data processing system 102), (ii) provide new and/or updated policies for data processing system 102 (e.g., to the management controller), (iii) provide supplemental data for data processing system 102 (e.g., to the management controller), and/or (iv) perform other actions (e.g., participate in provisioning processes for data processing system 102). For example, the supplemental data may include notifications regarding an occurrence of a secure communication modification event for data processing system 102, and/or instructions (e.g., commands) for remediating impacts of the secure communication modification event.

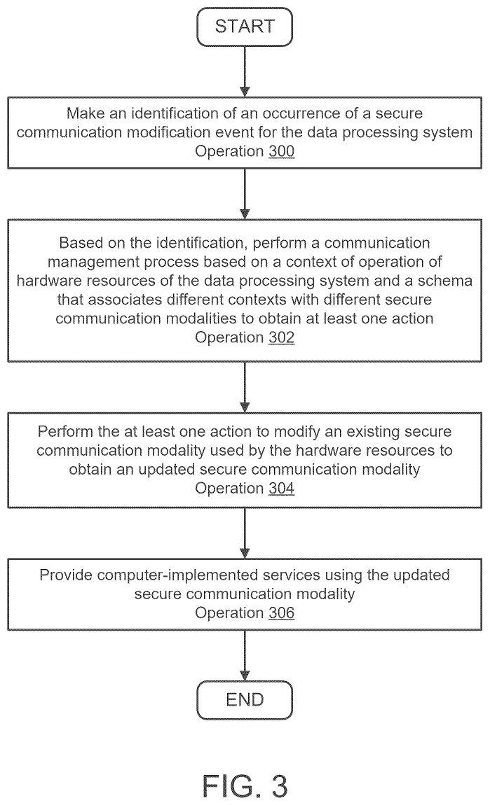

When providing their functionality, any of data processing system 102, service system 104, and/or components thereof may perform all, or a portion of the actions and methods illustrated in FIGS. 2A-3.

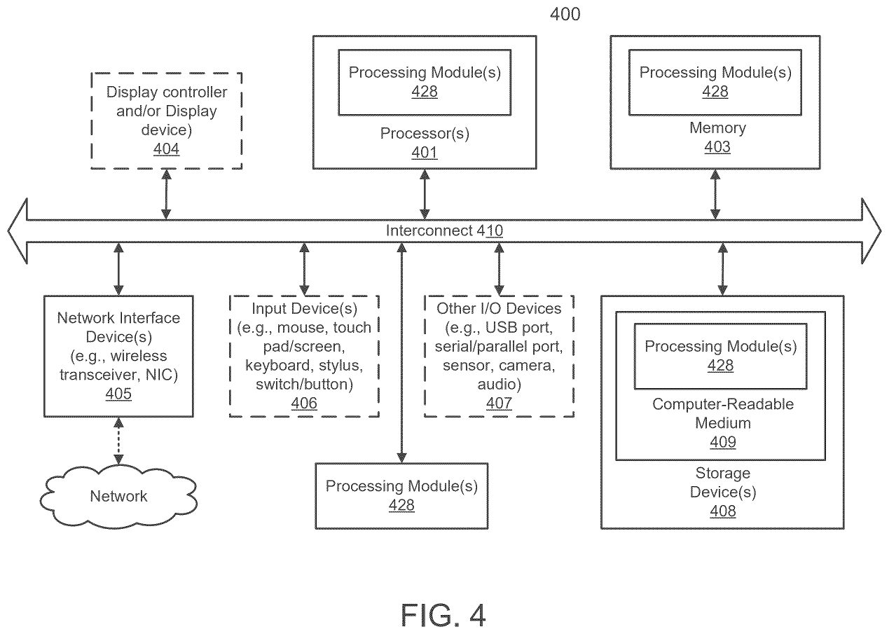

Any of data processing system 102 and service system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1A may be operably connected to each other (and/or components not illustrated) with communication system 106. Communication system 106 may facilitate communications between the components of FIG. 1A. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1A as including a limited number of specific components, a system in accordance with an embodiment may include fewer, additional, and/or different components than those illustrated therein.

Turning to FIG. 1B, a diagram illustrating a data processing system in accordance with an embodiment is shown. Data processing system 102 shown in FIG. 1B may be similar to any of the computing devices shown in FIG. 1A.

To provide computer-implemented services, data processing system 102 may include any quantity of hardware resources 150. Hardware resources 150 may be in-band (hardware) components, and may include a processor operably coupled to memory, storage, and/or other hardware components.

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, then these entities may subsequently compromise the operation of the applications. For example, if various drivers and/or the communication stack are compromised, then communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 102) to another device via any number of intermediate networks (e.g., via wired/wireless channels 176 that are part of the networks).

To reduce the likelihood of the applications and/or other in-band entities from being indirectly compromised, data processing system 102 may include management controller 152 and network module 160. Each of these components of data processing system 102 is discussed below.

Management controller 152 may be implemented, for example, using a system on a chip or other type of independently operating computing device (e.g., independent from the in-band components, such as hardware resources 150 of a host data processing system 102). Management controller 152 may provide various management functionalities for data processing system 102. Management controller 152 may, for example, monitor various ongoing processes performed by the in-band components, may manage power distribution, thermal management, and/or may perform other functions for managing data processing system 102. For example, management controller 152 may monitor activity of hardware resources 150 in order to identify occurrences of secure communication modification events (refer to FIG. 2B).

To do so, management controller 152 may be operably connected to various components via sideband channels 174 (in FIG. 1B, a limited number of sideband channels are included for illustrative purposes, it will be appreciated that management controller 152 may communicate with other components via any number of sideband channels such as sideband communication channel 174A shown in FIG. 2B). The sideband channels may be implemented using separate physical channels, and/or with a logical channel overlay over existing physical channels (e.g., logical division of in-band channels).

The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

The sideband channels may facilitate different secure communication modalities. For example, the different secure communication modalities may use different types of communication protocols and each of the different types of communication protocols may include different sets of parameters. The communication protocols and/or configuration thereof may be managed by management controller 152 via performance of various actions. For example, management controller 152 may modify quantities of and/or locations in memory used by the sideband channels to facilitate communication between management controller 152 and hardware resources 150, and/or perform other actions that may modify an existing pathway for data exchange used by the sideband channels.

To reduce the likelihood of indirect compromise of an application hosted by hardware resources 150, management controller 152 may, for example, enable information from other devices to be provided to the application without traversing the network stack and/or management entities of hardware resources 150. To do so, the other devices may direct communications including the information to management controller 152.

Management controller 152 may then, for example, send the information via sideband channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similarly, processes may be used to facilitate outbound communications from the applications.

Management controller 152 may be operably connected to communication components of data processing system 102 via separate channels (e.g., 172, 172A shown in FIG. 2B) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted components may not result in indirect compromise of any management controller 152, and entities hosted by management controller 152.

To facilitate communication with other devices, data processing system 102 may include network module 160. Network module 160 may provide communication services for in-band components and out-of-band components (e.g., management controller 152) of data processing system 102. To do so, network module 160 may include traffic manager 162, and interfaces 164.

Traffic manager 162 may include functionality to (a) discriminate traffic directed to various network endpoints advertised by data processing system 102, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

For example, when communicating with a remote system (e.g., service system 104), messages from the remote system may be addressed to a network endpoint advertised by network module 160 for out-of-band communications. The messages may include, for example, supplemental data for data processing system 102 and/or other information. When messages are received by traffic manager 162, traffic manager 162 may forward the message to management controller 152 via an out-of-band communication channel (e.g., channel 172), differentiating the message from in-band communications to data processing system 102.

By doing so, data processing system 102 may be more likely to obtain reliable supplementary data even when hardware resources 150 are compromised and/or inoperable. Similarly, messages sent from management controller 152 (e.g., including notifications regarding data processing system 102) to the remote system may be transmitted via the out-of-band communication channel to network module 160, bypassing the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wireless wide area network (WWAN) card, a Wi-Fi card, a wireless local area network card, a wired local area network card, an optical communication card, and/or other types of communication components. These components may support any number of wired/wireless channels 176.

Network module 160 may include a location component (not shown) with functionality for generating location data. The location component may include a global positioning system (GPS) receiver (e.g., for satellite-based geolocation), a cellular modem or chip (e.g., for cellular-based geolocation using a WWAN), sensors, and/or other types of geolocation components. The location component may, for example, transmit and/or receive data across a network via interfaces 164 in order to generate (e.g., triangulate) a location of data processing system 102. The location data may be forwarded by traffic manager 162 to management controller 152 via an out-of-band communication channel (e.g., channel 172), bypassing potentially compromised and/or unavailable hardware resources 150.

Thus, location data for data processing system 102 may be generated and/or provided by network module 160 independently from hardware resources 150 (e.g., and software hosted by hardware resources 150). Network module 160 may provide the location data to management controller 152 automatically based on a schedule, upon (automatic) detection of a change in location data (e.g., based on a displacement threshold), and/or upon obtaining a request for location data (e.g., from management controller 152). Management controller 152 may use the location data, for example, to identify a location for data processing system 102, which may be used, in part, to define a context of operation of hardware resources 150.

Thus, from the perspective of an external device, the in-band components and out-of-band components of data processing system 102 may appear to be two independent network entities that may be independently addressable and/or otherwise unrelated to one another.

To facilitate management of data processing system 102 over time, hardware resources 150, management controller 152 and/or network module 160 may be positioned in separately controllable power domains. By being positioned in these separate power domains, different subsets of these components may remain powered while other subsets are unpowered.

For example, management controller 152 and network module 160 may remain powered while hardware resources 150 is unpowered. Consequently, management controller 152 may remain able to communicate with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

Therefore, regardless of a state of hardware resources 150, the out-of-band components may remain powered in order to manage secure communication modalities used by hardware resources 150. For example, while hardware resources 150 are unpowered, power distribution may be managed so that management controller 152 may still (is) identify occurrences of secure communication modification events for data processing system 102 (e.g., obtain supplemental data provided by a remote system), (ii) perform communication management processes to obtain actions for modifying existing secure communication modalities used by hardware resources 150, and/or (iii) perform other actions for proactively managing the secure communication modalities (e.g., providing notifications regarding data processing system 102 to the remote system).

By doing so, when hardware resources 150 become powered, management controller 152 may initiate performance of the actions to obtain an updated secure communication modality prior to hardware resources 150 providing computer-implemented services (e.g., during startup).

To implement the separate power domains, data processing system 102 may include a power source (e.g., 180) that separately supplies power to power rails (e.g., power rail 184, power rail 186) that power the respective power domains. Power from the power source (e.g., a power supply, battery, etc.) may be selectively provided to the separate power rails to selectively power the different power domains. A power manager (e.g., 182) may manage power from power source 180, supplied via the power rails (e.g., by providing instructions via sideband channels 174). Management controller 152 may cooperate with power manager 182 to manage supply of power to these power domains. Management controller 152 may communicate with power manager 182 via sideband channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

To further clarify embodiments disclosed herein, a data flow diagram in accordance with an embodiment is shown in FIG. 2A. In this diagram, flows of data and processing of data are illustrated using different sets of shapes. A first set of shapes (e.g., 200, 202, etc.) is used to represent data structures, and a second shape (e.g., 206) is used to represent processes performed using data and/or that generate data.

Turning to FIG. 2A, the data flow diagram may illustrate data used in and data processing performed to obtain actions for modifying secure communication modalities used by hardware resources of a data processing system. For example, the data processing system may include communication channels (e.g., sideband channels 174) connecting the hardware resources and a management controller of the data processing system that facilitate an existing secure communication modality.

To obtain the actions for modifying the existing secure communication modality, communication management process 206 may be performed. During communication management process 206, context data 200, supplemental data 202, and/or policy data 204 may be used independently and/or in some combination to obtain action 208 (e.g., one or more actions for modifying the existing secure communication modality).

Context data 200 may include any quantity and/or type of information usable to define, at least in part, a context of operation of the hardware resources. For example, context data 200 may include (i) a location of the data processing system (e.g., location data), (ii) a time of occurrence of a secure communication modification event for the data processing system, (iii) a security status of the hardware resources (e.g., indicating likelihoods of compromise of portions of the hardware resources), (iv) a network connection status of the data processing system (e.g., information regarding network connectivity, stability, and/or security), and/or (v) other information (e.g., information regarding activity of the hardware resources).

Context data 200 may be generated, in part, by the hardware resources, and/or may be based on activity of the hardware resources. For example, context data 200 may include information regarding current and/or queued tasks (e.g., processes) for performance by the hardware resources and/or software hosted by the hardware resources (e.g., an operating system, applications). Context data 200 may include derived quantities. For example, context data 200 may include statistical characterizations of likelihoods of compromise of the hardware resources, network information, and/or information regarding the activity of the hardware resources.

Supplemental data 202 may include any quantity and/or type of information regarding the data processing system. For example, supplemental data 202 may include ownership information for the data processing system and/or information regarding whether the data processing system is lost and/or stolen. Supplemental data 202 may include different types of information (e.g., notifications) provided by a remote system trusted by the data processing system (refer to interaction 224 of FIG. 2B). Supplemental data 202 may be used (e.g., independently and/or in combination with context data 200) to identify occurrences of secure communication modification events and/or to obtain a context of operation of the hardware resources.

Policy data 204 may include any number of policies for the data processing system. Each policy of the policies may define a secure communication modality with a corresponding context of operation of the hardware resources. For example, each of the policies may be keyed to different secure communication modification events and/or different contexts of operation of the hardware resources. Therefore, a policy of the policies may be triggered by an occurrence of a particular secure communication modification event, and the policy may specify actions corresponding to a particular context of operation of the hardware resources given the occurrence of the particular secure communication modification event. The actions, when performed, may enforce the policy. For more information regarding identification of secure communication modification events, refer to the discussion of FIG. 2B.

Returning to communication management process 206, a schema may be used to obtain action 208. The schema may associate different contexts of operation of the hardware resources with different secure communication modalities. For example, the schema may include policies (e.g., policy data 204) and/or other data structures that specify rule-based actions for managing secure communication modalities in view of occurrences of secure communication modification events. During communication management process 206, actions for modifying the existing secure communication modality may be obtained.

Action 208 may include any number of actions for modifying the existing secure communication modality used by the hardware resources. For example, action 208 may include actions for modifying communication protocols used by sideband communication channels connecting the management controller and the hardware resources. The communication protocols may be configured using different parameters; therefore, action 208 may include actions for modifying parameters of the communication protocols.

For example, action 208 may include actions that, when performed, may (i) modify a quantity of memory of the hardware resources reserved for the existing secure communication modality (e.g., increase or decrease memory for data transmission), (ii) migrate a region of memory of the hardware resources reserved for the existing secure communication modality (e.g., redefine input/output memory addresses), and/or (iii) otherwise modify the existing secure communication modality (e.g., modify existing data pathways defined for various types of communication). For example, depending on a communication architecture of the data processing system, action 208 may include an action for designating a different communication channel for use by the hardware resources (e.g., during a period of time, for specific tasks, and/or for specific types of data).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Thus, using the data flows shown in FIG. 2A, a communication management process may be performed to obtain at least one action for modifying an existing secure communication modality used the hardware resources of a data processing system. The communication management process may be performed in response to an occurrence of a secure communication modification event for the data processing system, and may be based on a context of operation of the hardware resources.

To further clarify embodiments disclosed herein, an interaction diagram in accordance with an embodiment is shown in FIG. 2B. The interaction diagram may illustrate how data may be obtained and used within the system of FIGS. 1A-1B.

In the interaction diagram, processes performed by and interactions between components of a (distributed) system in accordance with an embodiment are shown. In the diagrams, components of the system are illustrated using a first set of shapes (e.g., 150, 152, etc.), located towards the top of each figure. Lines descend from these shapes. Processes performed by the components of the system are illustrated using a second set of shapes (e.g., 220, 226) superimposed over these lines.

Interactions (e.g., communication, data transmissions, etc.) between the components of the system are illustrated using a third set of shapes (e.g., 222, 224) that extend between the lines. The third set of shapes may include lines terminating in arrows that may indicate one-way interactions (e.g., data transmission from a first component to a second component). Some of the third set of shapes are drawn in dashing to indicate that corresponding interactions are optional and/or may not occur (e.g., 222).

Thick arrows (e.g., sideband communication channel 174A, out-of-band communication channel 172A) may indicate communication channels that facilitate multi-way interactions (e.g., data transmission between two components).

Generally, the processes and interactions are temporally ordered in an example order, with time increasing from the top to the bottom of each page. For example, the interaction labeled as 222 may occur prior to the interaction labeled as 224. However, it will be appreciated that the processes and interactions may be performed in different orders, any may be omitted, and other processes or interactions may be performed without departing from embodiments disclosed herein.

Turning to FIG. 2B, the interaction diagram may illustrate processes and interactions that may occur when obtaining an updated secure communication modality used by hardware resources of the data processing system.

The data processing system (e.g., data processing system 102) may include hardware resources 150, management controller 152, and/or other components (not shown). Hardware resources 150 may use an existing secure communication modality when providing computer-implemented services. For example, components of hardware resources 150 may communicate with one another and/or with management controller 152 using the existing secure communication modality.

However, over time (e.g., as a type of the computer-implemented services changes), the existing secure communication modality may be required to be updated in order to improve resource allocation and/or manage security risks. For example, a secure communication modification event for data processing system 102 may occur. The secure communication modification event may include a change in state of data processing system 102, a change in location of data processing system 102, and/or other types of events that, upon occurrence, may change communication requirements of hardware resources 150.

To identify occurrences of secure communication modification events, event identification process 220 may be performed by management controller 152. During event identification process 220, management controller 152 may (i) use sideband communication channel 174A to snoop activity of hardware resources 150 (not shown) in order to identify activity that corresponds to an occurrence of a secure communication modification event, and/or (ii) obtain information from other systems indicating the occurrence of the secure communication modification event (e.g., supplemental data from service system 104).

During event identification process 220, management controller 152 may report any identification of an occurrence of a secure communication modification event to a trusted remote system, such as service system 104. For example, a notification indicating a change in state of data processing system 102 (and/or other information indicating the occurrence of the secure communication modification event has been identified) may be provided to service system 104.

At interaction 222, the notification may be provided by management controller 152 to service system 104 over out-of-band communication channel 172A via (i) transmission via a message, (ii) storing in a storage with subsequent retrieval by service system 104, (iii) a publish-subscribe system where service system 104 subscribes to updates from management controller 152 thereby causing a copy of the notification to be propagated to service system 104, and/or (iv) other processes. Service system 104 may use the notification to alert an administrator of data processing system 102 and/or perform other actions to manage the occurrence of the communication modification event.

In a first example, the secure modification event may include initiation of a provisioning (or reprovisioning) process for data processing system 102. During the provisioning process, large volumes of data may be transferred from a provisioning system (e.g., service system 104) to hardware resources 150. The existing secure communication modality may not be configured in a manner that meets data transfer requirements for efficient performance of the provisioning process. For example, a quantity of memory dedicated to data transfer between components of data processing system 102 may be undersized and therefore may not meet the data transfer requirements.

In a second example, the secure modification event may include data processing system 102 entering a service mode (e.g., initiation of the service mode). While data processing system 102 is in the service mode, various layers of protection may be disabled in order to modify (e.g., reconfigure) underlying components of data processing system 102. For example, during the service mode, modifications may be made to the basic input output system (BIOS). The existing secure communication modality may not be configured in a manner that meets security requirements during the service mode. For example, the existing secure communication modality may allow an unseasoned user of data processing system 102 access to critical components of data processing system 102.

In a third example, the secure modification event may include data processing system 102 entering into a compromised state (e.g., a potentially compromised state, a state where hardware resources 150 are likely to be compromised). While in the compromised state, an operating system hosted by hardware resources 150 may become susceptible to malicious use.

For example, the existing secure communication modality may not meet security requirements for preventing malicious use of hardware resources 150 (e.g., sensitive data stored in and/or generated by hardware resources 150) and/or other components of data processing system 102.

During event identification process 220, management controller 152 may identify occurrences of secure communication modification events autonomously. For example, management controller 152 may detect activity of hardware resources 150 that corresponds to (i) initiation of the provisioning process, (ii) initiation of the service mode, and/or (iii) unauthorized and/or unexpected activity of (e.g., access to) hardware resources 150. Alternatively, management controller 152 may identify the occurrences of the secure communication modification based on supplemental data obtained from service system 104.

At interaction 224, service system 104 may provide the supplemental data to management controller 152 over out-of-band communication channel 172A via (i) transmission via a message, (ii) storing in a storage with subsequent retrieval by management controller 152, (iii) a publish-subscribe system where management controller 152 subscribes to updates from service system 104 thereby causing a copy of the supplemental data to be propagated to management controller 152, and/or (iv) other processes.

The supplemental data may include notifications regarding a state of data processing system 102 (e.g., commands for updating a state of data processing system 102), policies for data processing system 102, ownership information for data processing system 102, and/or other information regarding data processing system 102. The supplemental data may indicate to management controller 152 that a state of data processing system 102 has been modified (and/or will be modified at a future point in time). For example, the supplemental data may indicate that the provisioning process has been (or is schedule to be) initiated, service mode has been (or is scheduled to be) initiated, and/or that data processing system 102 has been reported as lost and/or stolen.

Management controller 152 may use the supplemental data, context data, and/or policies for data processing system 102 to manage the occurrence of the secure communication modification event during communication management process 226 by obtaining actions for modifying the existing secure communication modality. Communication management process 226 may be an example of communication management process 206 of FIG. 2A. During communication management process 226, a context of operation of hardware resources 150 may be obtained, and the context of operation may be used in combination with a schema to obtain at least one action for modifying the existing secure communication modality used by hardware resources 150.

Returning to the first example, wherein the provisioning process for data processing system 102 is initiated. A context of operation may be obtained based on context data for data processing system 102, such as a network connection status for data processing system 102. The network connection status may indicate that a network connection to hardware resources 150 is insufficient for performing the provisioning process (e.g., based on statistical characterizations of network connectivity for data processing system 102 and corresponding thresholds).

Based on the network connection status for data processing system 102, the schema (e.g., a policy for data processing system 102) may specify that the provisioning process is required to be performed out-of-band. To do so, management controller 152 may obtain provisioning data from service system 104 via out-of-band communication channel 172A, and may forward at least a portion of the provisioning data to hardware resources 150 via sideband communication channel 174A. The schema may specify an action for modifying the existing secure communication modality facilitated by sideband communication channel 174A used for data transfer during out-of-band provisioning processes. The action may include increasing a quantity of memory reserved for the existing secure communication modality in order to increase data transmission speeds between management controller 152 and hardware resources 150 during the out-of-band provisioning process.

Returning to the second example, wherein the service mode is initiated for data processing system 102. The service mode may include a remote service mode performed by an administrator of data processing system 102 (e.g., via service system 104). A context of operation may be obtained based on context data for data processing system 102, such as a security status of hardware resources 150. The security status may indicate that a portion of hardware resources 150 is likely to be exposed to an unauthorized party (e.g., based on a likelihood of compromise and a corresponding threshold).

Based on the likelihood of compromise of hardware resources 150, the schema may specify an action for modifying the existing secure communication modality facilitated by communication channels used during the service mode (e.g., sideband communication channel 174A, an in-band communication channel). The action may include migrating a region of memory of hardware resources 150 reserved for the existing secure communication modality in order to enable a new communication path for servicing tools used during the service mode. By doing so, the new communication path may be less likely to be identified by and/or used by the unauthorized party.

Returning to the third example, wherein data processing system 102 is in a compromised state. A context of operation may be obtained based on context data for data processing system 102, such as location data, and supplemental data from service system 104, such as a notification indicating data processing system 102 has been lost. The location data may indicate that data processing system 102 is in a geographical region associated with unauthorized use (e.g., malicious use) of hardware resources 150.

Based on the location of data processing system 102 and the reported loss of data processing system 102, a schema may specify an action for modifying the existing secure communication modality facilitated by communication channels used by hardware resources 150. The action may be associated with a high likelihood of malicious use of hardware resources 150. The action may include disabling the existing secure communication modality in order to prevent communication previously provided by the existing secure communication modality. By doing so, malicious use of hardware resources 150 may be more likely to be prevented.

The action(s) obtained (e.g., identified) during communication management process 226 may be performed during action performance process 228. For example, during action performance process 228, policies for data processing system 102 may be enforced; therefore, performing the action(s) may include initiating a pre-programmed policy action.

During action performance process 228, an updated secure communication modality used by hardware resources 150 may be obtained. The updated secure communication modality may be usable by hardware resources 150 to provide computer-implemented services. By using the updated secure communication modality to provide the computer-implemented services (rather than the existing secure communication modality), the computer-implemented services may be more likely to be provided securely, reliably, and/or otherwise as expected by consumers of the computer-implemented services.

Action performance process 228 may be initiated by and/or performed, at least in part, by management controller 152. Portions of action performance process 228 may be performed by management controller 152 and hardware resources 150 (e.g., via communications over sideband communication channel 174A) cooperatively and/or independently.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures.

Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using processes and interactions shown in FIG. 2B, an updated secure communication modality used by hardware resources of a data processing system may be obtained based on a context of operation of the hardware resources. By using out-of-band methods to manage secure communication modalities used by the hardware resources, reliance on potentially compromised and/or inoperable in-band components of the data processing system may be reduced.

Turning to FIG. 3, a flow diagram illustrating a method in accordance with an embodiment is shown. The flow diagram may illustrate various operations performed while managing secure communication modalities used by hardware resources of a data processing system.

At operation 300, an identification of an occurrence of a secure communication modification event for the data processing system may be made. The identification may be made by performing an event identification process similar to event identification process 220 of FIG. 2B and/or by other methods. For example, a management controller of the data processing system may identify the occurrence of the secure communication modification event by (i) snooping activity of the hardware resources via a sideband communication channel to identify activity that corresponds with an occurrence of the secure communication modification event, and/or (ii) receiving information indicating the occurrence of the secure communication modification event (e.g., notifications from the hardware resources via the sideband communication channel, notifications from a remote system, via an out-of-band communication channel).

At operation 302, based on the identification, a communication management process may be performed. The communication management process may be performed by using methods similar to those described with respect to communication management process 206 of FIG. 2A, communication management process 226 of FIG. 2B, and/or by other methods.

For example, the management controller may perform the communication management process by (i) obtaining a context of operation of the hardware resources, (ii) selecting a schema that associates different contexts with different secure communication modalities, and/or (ii) using the schema to obtain at least one action for modifying an existing secure communication modality used by the hardware resources.

The management controller may obtain the context of operation by obtaining and/or analyzing (e.g., parsing, obtaining a statistical characterization of) context data for the data processing system (e.g., context data 200 of FIG. 2A) and/or supplemental data (e.g., supplemental data 202 of FIG. 2A). For example, the context data and/or the supplemental data may be analyzed with respect to the schema.

The schema may be keyed to variables such as: a type of the secure communication modification event, the context data, and/or the supplemental data. The schema may associate the keyed variables with actions for modifying (existing) secure communication modalities for the data processing system. For example, the at least one action may be obtained by interrogating the schema to identify and/or select action(s) associated with the type of the secure communication modification event and portions of the context data and/or the supplemental data.

At operation 304, the at least one action may be performed to obtain an updated secure communication modality. The at least one action may be performed by performing an action performance process such as action performance process 228 of FIG. 2B and/or by other methods. For example, the at least one action may be performed by the management controller and/or the hardware resources by (i) obtaining (e.g., by the management controller) instructions usable for performing the at least one action, and/or (ii) inserting (e.g., by the management controller) at least a portion of the instructions into an execution flow for performance by the management controller and/or into an execution flow for performance by the hardware resources.

At operation 306, computer-implemented services may be provided using the updated secure communication modality. The computer-implemented services may be provided by (i) obtaining instructions based on input (e.g., from a user of the data processing system, from other devices, from storage), and/or (ii) inserting the instructions into an execution flow for performance by the hardware resources using the updated secure communication modality.

The method may end following operation 306.

Thus, as illustrated above, embodiments disclosed herein may provide systems and methods for out-of-band management of secure communication modalities used by hardware resources of a data processing system. The secure communication modalities may be managed without relying on secure operation of the hardware resources. By doing so, the hardware resources may be more likely to operate in compliance with communication policies for the data processing system, and the computer-implemented services provided using the operationally compliant hardware resources may be more likely to be secure and reliable for downstream consumers.

Any of the components illustrated in FIGS. 1A-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein.

Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
making an identification, by a management controller of the data processing system, of an occurrence of a secure communication modification event for the data processing system; and
based on the identification:
performing, by the management controller, a communication management process based on a context of operation of hardware resources of the data processing system and a schema that associates different contexts with different secure communication modalities to obtain at least one action,
performing, by the management controller, the at least one action to modify an existing secure communication modality used by the hardware resources to obtain an updated secure communication modality, and
providing, by the hardware resources, computer-implemented services using the updated secure communication modality.

2. The method of claim 1, wherein each of the different secure communication modalities utilizes a communication protocol of multiple communication protocols and a set of parameters of multiple sets of parameters for the communication protocol.

3. The method of claim 1, wherein the context of operation of the hardware resources is based on at least:
a location of the data processing system;
a time of the occurrence of the secure communication modification event;
a security status of the hardware resources; and
a network connection status of the data processing system.

4. The method of claim 3, wherein the context of operation of the hardware resources is further based on:
information regarding whether the data processing system is lost and/or stolen;
ownership information for the data processing system; and
information regarding the data processing system provided by another system.

5. The method of claim 1, wherein the schema comprises policies for the data processing system, and each policy of the policies defines a secure communication modality of the different secure communication modalities with a corresponding context of the different contexts.

6. The method of claim 5, wherein each of the policies are keyed to different secure communication modification events for the data processing system.

7. The method of claim 1, wherein the at least one action modifies a quantity of memory of the hardware resources reserved for the existing secure communication modality.

8. The method of claim 1, wherein the at least one action migrates a region of memory of the hardware resources reserved for the existing secure communication modality.

9. The method of claim 1, wherein the updated secure communication modality prevents communication previously provided by the existing secure communication modality.

10. The method of claim 1, wherein the data processing system comprises a network module adapted to separately advertise network endpoints for the management controller and the hardware resources, the network endpoints being usable by a remote system to address communications to the hardware resources and the management controller to facilitate the providing of the computer-implemented services.

11. The method of claim 10, wherein an out-of-band communication channel that services the management controller runs through the network module, an in-band communication channel that services the hardware resources also runs through the network module, and a sideband channel facilitates the updated secure communication modality.

12. A non-transitory machine-readable medium having instructions stored therein, which when executed by a processor, cause the processor to perform operations for managing operation of a data processing system, the operations comprising:
making an identification, by a management controller of the data processing system, of an occurrence of a secure communication modification event for the data processing system; and
based on the identification:
performing, by the management controller, a communication management process based on a context of operation of hardware resources of the data processing system and a schema that associates different contexts with different secure communication modalities to obtain at least one action,
performing, by the management controller, the at least one action to modify an existing secure communication modality used by the hardware resources to obtain an updated secure communication modality, and
providing, by the hardware resources, computer-implemented services using the updated secure communication modality.

13. The non-transitory machine-readable medium of claim 12, wherein each of the different secure communication modalities utilizes a communication protocol of multiple communication protocols and a set of parameters of multiple sets of parameters for the communication protocol.

14. The non-transitory machine-readable medium of claim 12, wherein the context of operation of the hardware resources is based on at least:
a location of the data processing system;
a time of the occurrence of the secure communication modification event;
a security status of the hardware resources; and
a network connection status of the data processing system.

15. The non-transitory machine-readable medium of claim 14, wherein the context of operation of the hardware resources is further based on:
information regarding whether the data processing system is lost and/or stolen;
ownership information for the data processing system; and
information regarding the data processing system provided by another system.

16. The non-transitory machine-readable medium of claim 12, wherein the schema comprises policies for the data processing system, and each policy of the policies defines a secure communication modality of the different secure communication modalities with a corresponding context of the different contexts.

17. A data processing system, comprising:
a processor; and
a memory coupled to the processor to store instructions, which when executed by the processor, cause operations to be performed, the operations comprising:
making an identification, by a management controller of the data processing system, of an occurrence of a secure communication modification event for the data processing system, and
based on the identification:
performing, by the management controller, a communication management process based on a context of operation of hardware resources of the data processing system and a schema that associates different contexts with different secure communication modalities to obtain at least one action;
performing, by the management controller, the at least one action to modify an existing secure communication modality used by the hardware resources to obtain an updated secure communication modality; and
providing, by the hardware resources, computer-implemented services using the updated secure communication modality.

18. The data processing system of claim 17, wherein each of the different secure communication modalities utilizes a communication protocol of multiple communication protocols and a set of parameters of multiple sets of parameters for the communication protocol.

19. The data processing system of claim 17, wherein the context of operation of the hardware resources is based on at least:
a location of the data processing system;
a time of the occurrence of the secure communication modification event;
a security status of the hardware resources; and
a network connection status of the data processing system.

20. The data processing system of claim 19, wherein the context of operation of the hardware resources is further based on:
information regarding whether the data processing system is lost and/or stolen;
ownership information for the data processing system; and
information regarding the data processing system provided by another system.
